(19) United States
(12) Patent Application Publication
(10) Pub. No.: US 2023/0411727 A1
(43) Pub. Date: Dec. 21, 2023

(54) BATTERY PACK INCLUDING A THERMAL MANAGEMENT ASSEMBLY AND A VEHICLE

(71) Applicant: Ford Global Technologies, LLC, Dearborn, MI (US)

(72) Inventor: Fei Gao, Hefei (CN)

(21) Appl. No.: 18/332,825

(22) Filed: Jun. 12, 2023

(30) Foreign Application Priority Data
Jun. 21, 2022 (CN) 2022107028765

(51) Int. Cl. H01M 10/625; H01M 50/249; H01M 10/6566; H01M 10/6554; H01M 10/658

(52) U.S. Cl. CPC H01M 10/625; H01M 50/249; H01M 10/6566; H01M 10/6554; H01M 10/658; H01M 2220/20

(57) ABSTRACT

A battery pack includes a first housing that defines a gap between at least a portion of it and a vehicle body; and a first guiding member arranged on the first housing. The first guiding member on the first housing defines an area jointly with the first housing, and the first guiding member is configured to at least partially fill the gap and guide airflow to at least partially bypass the area.

### CROSS-REFERENCE TO RELATED DISCLOSURES

This disclosure claims priority to Chinese Patent Disclosure No. 2022107028765, which was filed on 21 Jun. 2022 and is incorporated herein by reference in its entirety.

### TECHNICAL FIELD

The present disclosure relates to the field of vehicles, and specifically to a battery pack including a thermal management assembly and a vehicle.

### BACKGROUND

Electric vehicles differ from conventional motor vehicles in that they are selectively driven by one or more electric machines powered by traction batteries. The electric machines can drive the electric vehicles instead of, or in addition to, an internal combustion engines. Examples of the electric vehicles include hybrid electric vehicles (HEVs), plug-in hybrid electric vehicles (PHEVs), fuel cell vehicles (FCVs), and battery electric vehicles (BEVs).

With the development of the automotive industry, new energy vehicles are becoming increasingly popular. Battery temperature can influence battery performance. For example, in excessively cold weather, the range of the electric vehicles may significantly decrease, and appropriate temperature will help the electric vehicles have a longer driving range in cold winter weather. Therefore, providing a suitable working environment for battery packs is very important.

There are various battery pack designs in prior art that attempt to provide a suitable working environment for the battery packs. For example, CN215834598U discloses a battery pack, wherein an insulation chamber is arranged on a base of the battery pack and air in the insulation chamber reduces the transmission of heat.

### SUMMARY

The present disclosure summarizes aspects of the embodiments and should not be used to limit the claims. Other implementations are contemplated in accordance with the techniques described herein, as will be apparent upon examination of the following drawings and detailed description, and such implementations are intended to be within the scope of the present disclosure.

According to a first aspect of the present disclosure, a battery pack including a thermal management assembly is provided, comprising: a first housing that defines a gap between at least a portion of it and a vehicle body; and a first guiding member arranged on the first housing, wherein the first guiding member on the first housing defines an area jointly with the first housing, and the first guiding member is configured to at least partially fill the gap and guide airflow to at least partially bypass the area.

In an embodiment of the present disclosure, the guiding member comprises a structure that continuously extends from a first end of the first housing to a first side of the first housing and a second side opposite the first side.

In an embodiment of the present disclosure, the guiding member comprises a first portion extending along a first end of the first housing, and a second portion and a third portion extending from both ends of the first portion towards a second end opposite to the first end, respectively, and wherein an angled or smooth transition is formed between the first portion and the second portion and between the first portion and the third portion.

In an embodiment of the present disclosure, the first guiding member forms a substantially enclosed structure along an outer surface of the first housing.

In an embodiment of the present disclosure, the battery pack further comprises at least one second guiding member connected to the first housing, wherein the second guiding member is located in the area.

In an embodiment of the present disclosure, the first guiding member is configured with a multi-layer structure and includes a support layer connected to an outer surface of the first housing and a foam sealing layer connected to the support layer.

In an embodiment of the present disclosure, the outer surface forms a drainage channel with the support layer of the first guiding member.

In an embodiment of the present disclosure, the battery pack further comprises a second housing integrated with a cooling plate, and the second housing is connected to the first housing to limit a battery storage space.

In an embodiment of the present disclosure, the cooling plate comprises a first plate and a second plate connected to the first plate, and wherein at least one of the first plate and the second plate defines a fluid channel.

In an embodiment of the present disclosure, the battery pack further comprises further comprises a thermal insulation member connected to the second housing.

In an embodiment of the present disclosure, the thermal insulation member comprises an aluminum foil layer and a thermal insulation material inside the aluminum foil layer, and the thermal insulation material comprises aerogel or ceramic wool.

In an embodiment of the present disclosure, the second housing includes a protective plate between the second plate and the thermal insulation member, and the protective plate includes an edge overlap portion at its edge.

In an embodiment of the present disclosure, the second plate comprises at least one notch formed on it.

In an embodiment of the present disclosure, the battery pack comprises a support beam welded to the first plate at a position corresponding to the notch.

In an embodiment of the present disclosure, the first plate includes a positioning pin hole, and the second plate includes a positioning recess corresponding to the positioning pin hole and configured to receive a removable positioning member.

In an embodiment of the present disclosure, the removable positioning member includes a positioning portion configured to extend through the positioning pin hole and be received by the positioning recess and a limiting portion that is transverse to the positioning portion and configured to limit movement range of the positioning portion to maintain the integrity of the positioning recess.

In an embodiment of the present disclosure, the cooling plate comprises at least two sets of parallel independent fluid channel subsystems, wherein the independent fluid channel subsystems are connected to a heat exchange system of a vehicle.

In an embodiment of the present disclosure, each set of the fluid channel subsystems includes a heat exchange circulating liquid inlet and a heat exchange circulating liquid outlet, a first main channel and a second main channel extending between the heat exchange circulating liquid inlet and the heat exchange circulating liquid outlet, and multiple sets of auxiliary channels extending between the first main channel and the second main channel.

According to a second aspect of the present disclosure, a vehicle is provided, comprising a battery pack connected to a vehicle body and forming a gap with the vehicle body, wherein the vehicle includes a guiding member that is generally adjacent to the battery pack to guide airflow to at least partially bypass the gap.

In an embodiment of the present disclosure, the guiding member generally surrounds ends and both sides of the battery pack, wherein the guiding member is connected to a housing of the battery pack or to the vehicle body.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

For a more complete understanding of the embodiments of the present disclosure, reference should be made to the embodiments described in more detail in the attached drawings and described by examples below.

FIG. 1 shows a schematic diagram of an exemplary vehicle;

FIG. 2 shows a schematic diagram of an exemplary first housing according to an embodiment of the present disclosure;

FIG. 3 shows a cross-sectional schematic diagram of an exemplary first guiding member according to an embodiment of the present disclosure;

FIG. 4 shows an enlarged schematic diagram of box A in FIG. 2;

FIG. 5 shows a exploded schematic diagram of an exemplary second housing according to an embodiment of the present disclosure;

FIG. 6 shows a schematic diagram of an exemplary cooling plate according to an embodiment of the present disclosure;

FIG. 7 shows a partial schematic diagram of an interior of an exemplary battery pack according to an embodiment of the present disclosure;

FIG. 8 shows a schematic diagram of a bottom of an exemplary second housing according to one embodiment of the present disclosure;

FIG. 9 shows a cross-sectional schematic diagram of an exemplary thermal insulation member according to an embodiment of the present disclosure;

FIG. 10 shows a cross-sectional schematic diagram of an exemplary removable positioning member and a cooling plate according to an embodiment of the present disclosure;

FIG. 11 shows a schematic diagram of a vehicle including an exemplary battery pack according to an embodiment of the present disclosure;

FIG. 12 shows a schematic diagram of an exemplary thermal management system according to an embodiment of the present disclosure; and

FIGS. 13a and 13b show schematic diagrams of exemplary first guiding members according to embodiments of the present disclosure.

### DETAILED DESCRIPTION

Embodiments of the present disclosure are described below. However, it should be understood that the disclosed embodiments are only examples, and other embodiments may take various alternative forms. Drawings are not necessarily drawn to scale; and some functions may be exaggerated or minimized to show details of specific components. Therefore, the specific structural and functional details disclosed herein should not be interpreted as restrictive, but merely as a representative basis for teaching those skilled in the art to use the present disclosure in various ways. As will be understood by those of ordinary skill in the art, various features shown and described with reference to any one of the drawings may be combined with features shown in one or more other drawings to produce embodiments which is not explicitly shown or described. The combination of the features shown provides a representative embodiment for a typical disclosure. However, various combinations and modifications of features consistent with the teachings of the present disclosure may be expected for certain specific disclosures or embodiments.

Further, in this document, relational terms, such as first and second and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The motor vehicle involved in the following embodiments can be standard gasoline powered vehicle, hybrid electric vehicle (HEV), electric vehicle (BEV), plug-in hybrid electric vehicle (PHEV), full hybrid electric vehicle (FHEV), fuel cell vehicle and/or any other type of vehicles, as well as bus, ship or aircraft. The vehicle includes components related to mobility, such as engine, electric motor, transmission, suspension, drive shaft and/or wheels, etc. The vehicle can be nonautonomous, semi-autonomous (for example, some conventional motion functions are controlled by the vehicle) or autonomous (for example, motion functions are controlled by the vehicle, without direct input from driver).

According to a first aspect of the present disclosure, a battery pack including a thermal management assembly is provided, comprising: a first housing that defines a gap between at least a portion of it and a vehicle body; and a first guiding member arranged on the first housing, wherein the first guiding member on the first housing defines an area jointly with the first housing, and the first guiding member is configured to at least partially fill the gap and guide airflow to at least partially bypass the area. The thermal management assembly described in the present disclosure can at least include the first guiding member, a second guiding member, a thermal insulation member, a cooling plate, etc. as specified below, and these components can be separate components and subsequently assembled with the battery pack. In one embodiment, one or more of these components, such as the first guiding member and the second guiding member, can be integrally formed with other components of the vehicle or assembled in a manner adjacent to a housing (such as the first housing and a second housing as described below) of the battery pack.

In another embodiment, these components can be directly connected and assembled with the housing of the battery pack. In some other embodiments, these components can be integrated with the first or second housing of the battery pack to form a portion of the battery pack, providing a good working environment for the battery pack, such as providing a more suitable working temperature for the battery pack in hot summer or cold winter, and thus improving working performance of the battery pack to a certain extent, for example, to increase the driving range of the vehicle. In addition, the present disclosure has a concise technical solution design, which can make packaging space of the battery pack more compact. According to the present disclosure, the first and second guiding members are related to thermal management of the battery pack and can be understood as components used to guide the airflow. In some embodiments, the housing of the battery pack comprises a first material, and the first and second guiding members comprise a second material different from that of the housing of the battery pack. The first material has a higher thermal conductivity than the second material. In other embodiments, the second material is a flexible material. In addition, the first and/or second housing of the battery pack may also include components such as ribs and reinforcing ribs that increase strength of the housing, as well as components such as fasteners and connectors for connection, and these components can be understood as mechanical related components. It should be understood that the components related to the thermal management of the battery pack described in the present disclosure (such as the first guiding member, second guiding member) do not belong to the mechanical related components, and can be clearly distinguished from the mechanical related components in terms of structure, material, purpose, and effect.

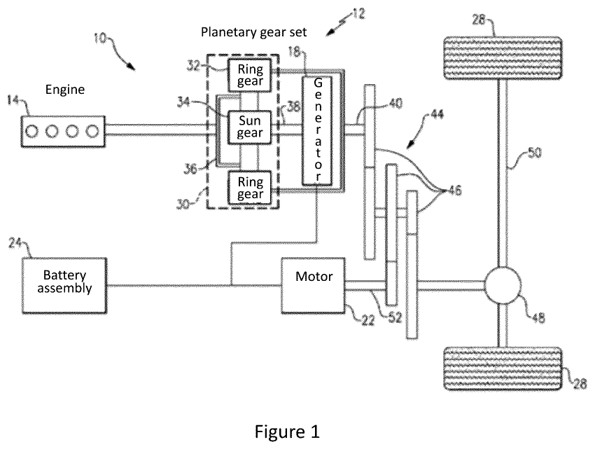

Referring to FIG. 1, one example of a vehicle 12 is shown. Although depicted as a hybrid electric vehicle (HEV), it should be understood that the present disclosure may be applied to other types of electric vehicle, such as plug-in deep hybrid electric vehicles (PHEV), pure electric vehicles (BEV), full hybrid electric vehicles (FHEV), etc.

In one embodiment, a powertrain 10 is a power-split powertrain system that includes a first drive system and a second drive system. The first drive system includes a combination of an engine 14 and a generator 18 (i.e., a first electric machine). The second drive system includes at least a motor 22 (i.e., a second electric machine), the generator 18, and a battery assembly 24. In this example, the second drive system is considered an electric drive system of the powertrain 10. The first and second drive systems generate torque to drive one or more sets of vehicle drive wheels 28 of the vehicle 12. Although a power-split configuration is shown in this illustrative embodiment of FIG. 1, this disclosure extends to any hybrid electric vehicle including full hybrids, parallel hybrids, series hybrids, mild hybrids or micro hybrids. The engine 14 and the generator 18 may be connected through a power transfer unit 30. In addition to planetary gear set, other types of power transfer units may be used to connect the engine 14 to the generator 18. In a non-limiting embodiment, the planetary gear set includes a ring gear 32, a sun gear 34, and a carrier assembly 36.

The generator 18 can be driven by the engine 14 through the power transfer unit 30 to convert kinetic energy to electrical energy. The generator 18 can alternatively function as a motor to convert electrical energy into kinetic energy, thereby outputting torque to a shaft 38 connected to the power transfer unit 30. Because the generator 18 is operatively connected to the engine 14, the speed of the engine 14 can be controlled by the generator 18.

The ring gear 32 of the power transfer unit 30 may be connected to a shaft 40, which is connected to vehicle drive wheels 28 through a second power transfer unit 44. The second power transfer unit 44 may include a gear set having a plurality of gears 46. Other power transfer units may also be suitable. The gears 46 transfer torque from the engine 14 to a differential 48 to ultimately provide traction to the vehicle drive wheels 28. The differential 48 may include a plurality of gears that enable the transfer of torque to the vehicle drive wheels 28. In one embodiment, the second power transfer unit 44 is mechanically coupled to an axle 50 through the differential 48 to distribute torque to the vehicle drive wheels 28.

The battery assembly 24 is an example type of battery assembly for the electric vehicles. The battery assembly 24 may provide power to drive a motor, and in regenerative braking, the motor 22 and generator 18 may output power to the battery assembly 24 for storage. The battery assembly 24 may include a battery pack, which may include one or more battery arrays and a thermal management assembly. In the following embodiments, the battery packs that can be incorporated into the battery assembly 24 in the above example are provided.

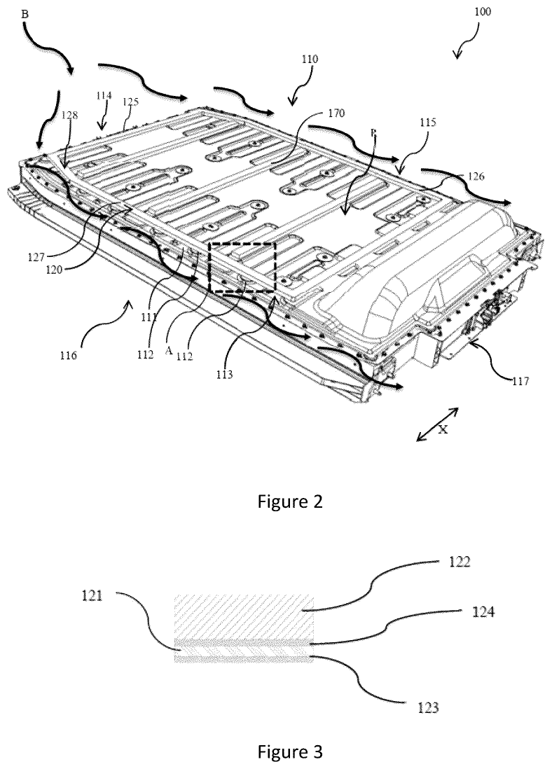

Referring to FIGS. 2-12, according to embodiments of the present disclosure, a battery pack 100 may include a first housing 110 and a second housing 130, which are connected to limit a battery storage space for accommodating battery arrays (not shown in the figure). In one embodiment of the present disclosure, the first housing 110 may be a cover, and the second housing 130 may be a tray. In another embodiment of the present disclosure, the first housing 110 can be a tray, and the second housing 130 can be a cover. The first and second housings can be tray or cover with a certain accommodating space, and as an alternative, one of the first and second housings can also be a flat cover. In addition, specific shapes of the first and second housings are not specifically limited here, and the first and/or second housings can be made of other commonly used materials such as steel, aluminum, etc.

The battery pack can usually be located at the bottom of a vehicle. In the embodiment shown in FIG. 11, the battery pack 100 can be located at the bottom of a vehicle 1 and connected to a vehicle body 2 of the vehicle 1. Referring to FIG. 2 on the basis of FIG. 11, FIG. 2 illustrates an exemplary first housing 110, such as a cover of the battery pack 100. After the battery pack 100 is connected to the vehicle body 2, a gap D for decking clearance is formed between at least a portion of the first housing 110 and the vehicle body 2. The gap D will form a channel that allows airflow to pass through (not shown in the figure). In one embodiment, the gap D is approximately 4-15 millimeters. It should be understood that the size of the gap D can be provided according to the actual situation, for example, depend on different vehicle models and battery pack sizes.

The first housing 110 can be made of materials with good thermal conductivity. Thus, heat inside the battery pack 100 will be carried away by the airflow flowing through the channel, causing the temperature of the battery arrays (not shown in the figure) inside the battery pack 100 to rapidly decrease. This situation is more pronounced in cold winter.

In addition, the gap D may also compress the gas inside the gap D, causing the gas to emit unexpected sounds during vehicle driving, in some examples such as high-speed driving.

To address these issues, the battery pack 100 can include a first guiding member 120 arranged on the first housing 110, the first guiding member 120 on the first housing 110 defines an area R jointly with the first housing 110, and the first guiding member 120 can at least partially fill the gap D and guide airflow to at least partially bypass the area R (as shown by multiple arrows B in FIG. 2), thereby at least partially “closing” the channel to minimize the heat carried away by the airflow inside the battery pack 100 and thus maintain the temperature of the battery arrays, which can be particularly beneficial in cold winter in some examples.

In the case where the temperature of the battery pack is governed and controlled through a cooling plate and cooling channel during high summer temperatures (as described in other parts of the present disclosure), the first guiding member mentioned above can further assist the battery pack in maintaining the suitable working temperature to minimize the influence of external temperature on the battery pack as much as possible.

In some embodiments, at least some areas of the first and/or second guiding members along a vehicle height direction have dimensions roughly equal to that of the gap D. In other embodiments, at least some areas of the first and/or second guiding members along the vehicle height direction have dimensions greater than that of the gap D. After assembly is completed, the first and/or second guiding members are moderately compressed to fully fill the gap D in the vehicle height direction. In some embodiments, in a plane of the housing of the battery pack, overall dimensions of the first and/or second guiding members have a projection that is generally smaller than the area R defined by the first and/or second guiding members. This structure is conducive to controlling overall packaging size, weight, and improving the effect of temperature control.

In an embodiment of the present disclosure, the first guiding member 120 can be arranged to form a substantially enclosed structure along an outer surface 111 of the first housing 110 to define an enclosed area R. In the embodiment shown in FIG. 2, the first guiding member 120 can be formed into a substantially ship-shaped enclosed structure, which can include a substantially straight first portion 125 extending along a first end 114 of the first housing 110, and a substantially straight second portion 126 and third portion 127 extending along a first side 115 and second side 116 from both ends of the first portion 125, respectively. The first portion 125 can form an angled or smooth transition 128 with the second portion 126 and the third portion 127, respectively. The transitions 128 can be used to further guide the airflow. As shown in FIG. 2, the transitions 128 can form obtuse angles with the first portion 125, the second portion 126, or the third portion 127, respectively. In another embodiment, forming sharp angles is also possible. In other embodiments, the first portion 125 can also smoothly transition with the second portion 126 and the third portion 127 in shapes such as arcs, respectively. When the airflow approaches the first housing 110 from the first end 114, the first guiding member 120 will guide the airflow to bypass the area R and guide the airflow to the first side 115 and the second side 116 of the first housing 110, respectively, as shown by arrow B. The enclosed area R can roughly correspond to the area containing the battery arrays. Therefore, this ship-shaped enclosed structure helps to alleviate temperature loss that occurs in the battery arrays. In addition, as the guiding member is at least partially filled with the gap D, the noise problem caused by the gap D can be alleviated.

Although the first guiding member 120 is illustrated in the embodiment of FIG. 2 using the enclosed ship-shaped structure as an example, in other embodiments of the present disclosure, the first guiding member 120 may also include other structures. In an embodiment of the present disclosure, the first guiding member 120 may include a structure that extends continuously from the first end 114 of the first housing 110 to the first side 115 of the first housing 110 and the second side 116 opposite to the first side 115. For example, this structure can be non-enclosed to limit a non-enclosed area R. For example, the first guiding member 120 can extend continuously from the first end 114 along the first side 115 and the second side 116 to the second end 117, but is not enclosed at the second end 117. In addition, the portion of the first guiding member 120 along the first end 114, and the portion along the first side 115 and the second side 116, respectively, can also be in a non-straight shape, such as a curved shape or other shape adapted to the design of the outer surface 111 of the first housing 110.

In another embodiment of the present disclosure, the first guiding member 120 may include a first portion 125 extending along the first end 114 of the first housing 110, as well as a second portion 126 and a third portion 127 extending from both ends of the first portion 125 towards the second end 117 opposite the first end 114, respectively. For example, at least one of the second portion 126 and third portion 127 may not extend along the first side 115 or the second side 116, but may extend towards the second end 117 at any position on the outer surface 111. In addition, the first portion 125 may at least partially include a curved or other non-straight shape, and there may be no obvious transition between the first portion 125 and the second portion 126 and between the first portion 125 and the third portion 127. Instead, the first portion 125 may form a transition with the second portion 126 and the third portion 127 as a whole for further guiding the airflow.

For example, as shown in FIG. 13a, the first guiding member can form a roughly arched shape without being clearly divided into the first, second, and third portions. Any curved segment in the arched shape can serve as a transition for further guiding the airflow.

As shown in FIG. 13b, the first guiding member can form a roughly lunar shape without being clearly divided into the first, second, and third portions. In other embodiments, the first guiding member can also be formed into an irregular shape that can guide the airflow to bypass the area R. Those skilled in the art should understand that the first guiding member 120 can be configured with any shape that can generally guide the airflow to bypass the area R.

In an embodiment of the present disclosure, the battery pack 100 can further include at least one second guiding member 170 connected with the first housing 110. The second guiding member 170 can include a foam sealing layer and a bonding layer (not shown in the figure) and is located in the area R. The foam sealing layer is connected with the outer surface 111 of the first housing 110 through the bonding layer, and the bonding layer can include an adhesive tape, foam glue and other adhesives that can connect the foam material layer with the first housing.

Due to the presence of the gap D and the fact that the first housing 110 is usually a sheet metal part, during vehicle operation, the first housing 110 may come into contact with the vehicle body due to vibration, resulting in noise. The second guiding member 170 arranged in the area R can effectively reduce the contact between the first housing 110 and the vehicle body, and thus reduce the generation of noise. In addition, the second guiding member 170 can also form a separate airflow insulation chamber in the area R, which helps to isolate the air flow between the first housing 110 and the vehicle body 2 as much as possible, and thus reduce the heat carried away by the local air flow cycle in the area R from the local battery arrays. In the embodiment shown in FIG. 2, three sets of second guiding member 170 extending parallel to each other in a transverse direction X of the battery pack 100 are shown, thereby defining four separate airflow insulation chambers in the area R.

In an embodiment of the present disclosure, the first guiding member 120 can be configured with a multi-layer structure. In the embodiment shown in FIG. 3, the first guiding member 120 may include a support layer 121 connected with the outer surface 111 of the first housing 110 and a foam sealing layer 122 connected with the support layer 121. The support layer 121 can be made of hard materials, such as common hard plastics such as PP (polypropylene), PMMA (polymethyl methacrylate), PC (polycarbonate), etc. In addition, the first guiding member 120 may further include a first bonding layer 123 between the outer surface 111 and the support layer 121 and a second bonding layer 124 between the support layer 121 and the foam sealing layer 122. The first bonding layer 123 and/or the second bonding layer 124 can include an adhesive tape, foam glue and other adhesives that can realize the connection between the first housing and the support layer, and between the support layer and the foam sealing layer.

It can be advantageous to provide the support layer 121. On one hand, the hard support layer 121 can provide a certain support stiffness to prevent the foam sealing layer 122 from compressing and contacting the outer surface 111 of the first housing 110. On the other hand, the support layer 121 can form a drainage channel 113 with the outer surface 111 of the first housing 110, and foreign objects such as salt mist, water, etc. that exist on the outer surface 111 of the first housing 110 can be discharged through the drainage channel 113.

In an embodiment of the present disclosure, the outer surface of the first housing 110 may include ribs 112 that may protrude outward from the outer surface 111 of the first housing 110 to increase the strength of the first housing 110. As shown in FIG. 2, multiple ribs 112 are arranged to form protrusions relative to the portion without ribs 112 on the outer surface 111 and distributed on the outer surface 111. The ribs 112 can form the drainage channel 113 with the support layer 121.

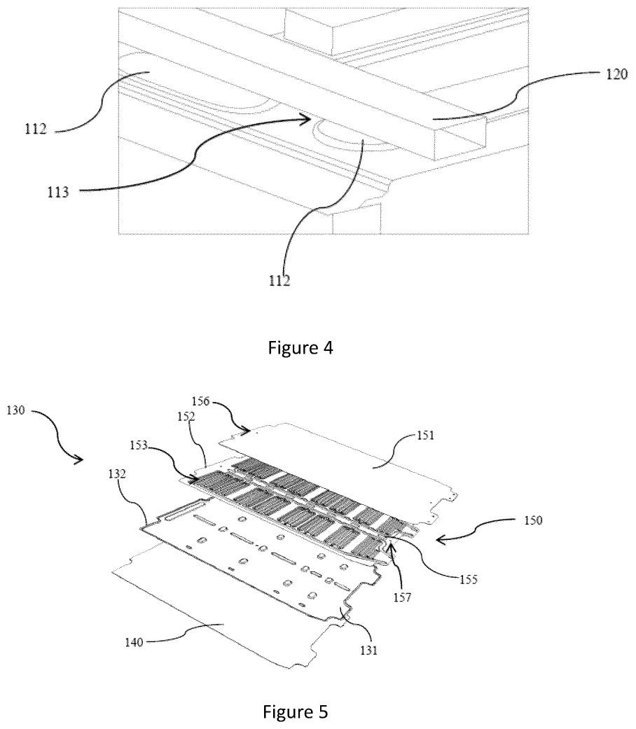

As shown in FIG. 4, two adjacent ribs, the first guiding member 120, and the outer surface 111 can define the drainage channel 113 to discharge salt mist and water that may exist in the area R, thereby minimizing corrosion of the first housing 110 and components such as connectors (such as bolts) used to connect the first housing 110.

In another embodiment of the present disclosure, the outer surface 111 of the first housing 110 may include ribs that are concave towards the interior of the first housing 110, and the concave ribs can also form a drainage channel with the support layer 121.

In an embodiment of the present disclosure, the second housing 130 may be a housing integrated with a cooling plate. FIG. 5 shows an exploded schematic diagram of the second housing 130 integrated with a cooling plate 150. The second housing 130 can include the cooling plate 150 and a protective plate 131 arranged below the cooling plate 150. In addition, the battery pack 100 can also include a thermal insulation member 140 located below the protective plate 131.

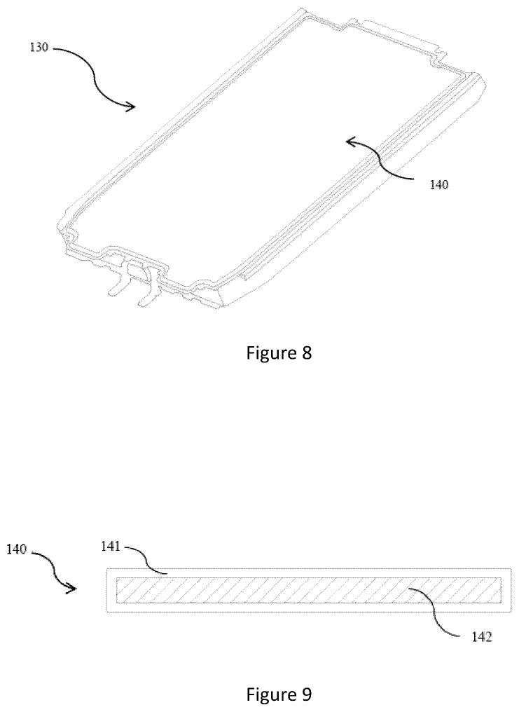

Referring to FIG. 8, the thermal insulation member 140 located on an outermost part of the second housing 130 is shown. The thermal insulation member 140 can be integrally covered at the bottom of the second housing 130, for example, by adhesive or other means. The thermal insulation member 140 can include an aluminum foil layer 141 and a thermal insulation material 142 inside the aluminum foil layer 141. The aluminum foil layer 141 can play an anti-corrosion role, and it can completely wrap the thermal insulation material 142, thereby preventing escape of the thermal insulation material. The thermal insulation material 142 plays a thermal insulation role and can minimize the influence of external environmental temperature on the temperature control of the battery pack in environments.

In one embodiment, the first guiding member 120 and second guiding member 170 located on the first housing 110 of the battery pack 100 and the thermal insulation member 140 located on the second housing 130 can cooperate with each other to assist the cooling plate 150 in maintaining the adjusted temperature of the battery pack 100 in a suitable working range.

In the embodiment shown in FIG. 9, the thermal insulation material 142 is filled inside the aluminum foil layer 141. In an embodiment, the thermal insulation member 140 can have a thickness of 2-7 millimeters, wherein the aluminum foil layer 141 can have a thickness of 0.2-0.8 millimeters, and the thermal insulation material 142 can have a thickness of 1.5-6 millimeters.

It should be understood that the above thickness range is only shown as an example, and other thicknesses are also included within the scope of the present disclosure. In an embodiment, the thermal insulation material 142 can include aerogel or ceramic wool, wherein the aerogel can be filled in the aluminum foil layer 141, and the ceramic wool can be folded in the aluminum foil layer 141.

In an embodiment of the present disclosure, the cooling plate 150 may include a first plate 151 and a second plate 152 connected to the first plate 151, wherein at least one of the first plate 151 and the second plate 152 can define a fluid channel 153. In the embodiment shown in FIG. 5, the second plate 152 can be a channel plate stamped with a fluid channel 153, and the first plate 151 can be a sealing plate for contacting with the battery arrays. The second plate 152 can be connected to the protective plate 131, for example, welded together through an edge overlap portion of the protective plate 131 as described below.

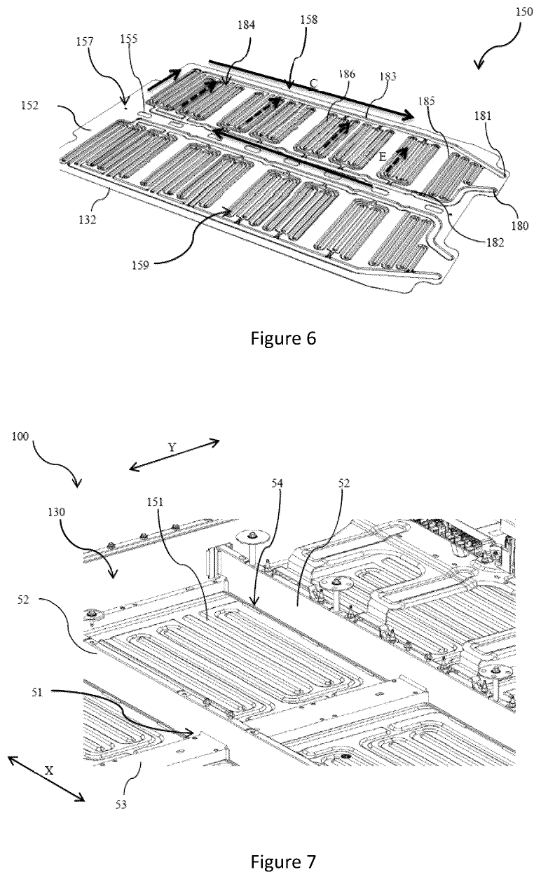

FIG. 6 shows a schematic diagram of the protective plate 131 and the second plate 152 in a connected state. The first plate 151 and the second plate 152 can be connected together through welding processes such as brazing. Although the first plate 151 is shown in the form of an overall flat plate in FIG. 5, it can be understood that in other embodiments, the first plate 151 can also form a shape or pattern corresponding to the fluid channel on its surface (as shown in FIG. 7), or the first plate 151 and the second plate 152 can jointly define the fluid channel. The second housing 130 integrated with the cooling plate 150 reduces complexity and saves packaging space of the second housing 130, thereby reducing packaging space of the battery pack 100, compared to the design that includes multiple separate cooling plates and related cooling hoses in the prior art.

Further referring to FIG. 7, which shows a schematic diagram of an interior of the battery pack 100, the battery arrays has been omitted for clarity. The omitted battery arrays can be directly placed on the first plate 151 of the cooling plate 150, thereby utilizing the heat exchange circulating liquid inside the cooling plate 150 to exchange heat with the battery arrays. In addition, the battery pack 100 can also include a support beam 51 arranged within the second housing 130. The support beam 51 is a relatively rigid hollow or solid structure, for example, and can be arranged between adjacent battery arrays. The support beam 51 can increase the stiffness of the battery arrays and establish an installation point for fixing the first housing 110 to the second housing 130 (not shown in the figure). The support beam 51 can include multiple first beams 52 extending along the transverse direction X of the battery pack 100 and a second beam 53 extending along a longitudinal direction Y of the battery pack 100. The second beam 53 can be connected to the cooling plate 150, and the first beam 52 and the second beam 53 are connected to the cooling plate 150. In one embodiment, the first beam 52 and the second beam 53 can be welded to the cooling plate 150. In another embodiment, in addition to being welded to the cooling plate 150, the first beam 52 and/or the second beam 53 can be further connected to the cooling plate 150 through connectors such as bolts.

Typically, materials used to manufacture the first plate 151 and the second plate 152 of the cooling plate 150 can include aluminum. When welding (such as laser welding) two aluminum plates, brazing flux is usually added between the two aluminum plates to form a brazing layer between them, thereby welding the two aluminum plates together. Due to the brazing layer has a melting point of about 300° C., while the aluminum plates have a melting point of about 600° C., it is easy to generate welding spatter on the brazing layer during laser welding, resulting in unexpected welding spatter holes. To minimize the occurrence of welding spatter as much as possible, the second plate 152 may include at least one notch 155 formed on it, as shown in FIGS. 5 and 6. The notch 155 can be formed by partially hollowing out the second plate 152. Due to the presence of the notch 155, when the first plate 151 and the second plate 152 are welded together, there is no brazing layer in the area corresponding to the notch 155. For the second beam 53, it can be penetrated and welded to the first plate 151 at a position corresponding to the notch 155, so that the welding spatter will not occur due to the lack of brazing layer in the welding area where the penetration welding is carried out. It should be understood that although elliptical notches are shown in the embodiments shown in FIGS. 5 and 6, other regular or irregularly shaped notches are also within the scope of the present disclosure.

For the first beam 52, it can be directly welded to the first plate 151 without passing through the first plate 151. As shown in FIG. 7, a welding area 54 between the first beam 52 and the first plate 151 is shown. Although the position corresponding to the welding area 54 on the cooling plate 150 contains a brazing layer, as the welding between the first beam 52 and the first plate 151 does not pass through the first plate 151 or disrupt the brazing layer, the welding spatter will not occur. It should be understood that a notch similar to notch 155 can also be provided at the welding area corresponding to the first beam 52 on the second plate 152 as needed, so that the first beam 52 can be penetrated and welded to the first plate 151, and such embodiment is also within the scope of the present disclosure.

In an embodiment, the first plate 151 and the second plate 152 may have the same shape, while the protective plate 131 may also have shape corresponding to the first plate 151 and the second plate 152. In addition, as mentioned above, the protective plate 131 may include an edge overlap portion 132 arranged at its edge. The edge overlap portion 132 is formed by extending a portion of the protective plate 131 corresponding to the first plate 151 and the second plate 152, for example, 2-6 millimeters outward, as shown in FIGS. 5 and 6. By welding the second plate 152 through the edge overlap portion 132, it is possible to minimize the occurrence of the welding spatter while ensuring connection with the second plate 152 and thus with the first plate 151.

In an embodiment of the present disclosure, the cooling plate may include at least two sets of parallel independent fluid channel subsystems. Each set of the fluid channel subsystems can include a heat exchange circulating liquid inlet and a heat exchange circulating liquid outlet, a first main channel and a second main channel extending between the heat exchange circulating liquid inlet and the heat exchange circulating liquid outlet, and multiple sets of auxiliary channels extending between the first main channel and the second main channel.

In the embodiment shown in FIG. 6, for illustrative purposes, the first plate 151 is omitted. As shown in the figure, the cooling plate 150 can include two sets of fluid channel subsystems, namely, a first fluid channel subsystem 158 and a second fluid channel subsystem 159. The first fluid channel subsystem 158 and the second fluid channel subsystem 159 can be symmetrically distributed on both sides of the cooling plate 150. As an example, the first fluid channel subsystem 158 can include a heat exchange circulating liquid inlet 180, a heat exchange circulating liquid outlet 181, and a first main channel 182 and a second main channel 183 extending between the heat exchange circulating liquid inlet 180 and the heat exchange circulating liquid outlet 181. In addition, the first fluid channel subsystem 158 can also include multiple sets of parallel auxiliary channels 184 extending between the first main channel 182 and the second main channel 183.

Each set of the auxiliary channels 184 will have similar temperatures, thereby helping to balance the temperature between multiple battery arrays. The auxiliary channel 184 can include subchannel 185 connected in series, subchannel 186 connected in parallel, or a combination of them. The heat exchange circulating liquid (not shown in the figure) can enter from the heat exchange circulating liquid inlet 180, with a portion of the heat exchange circulating liquid flowing along the first main channel 182 to the second main channel 183 (as shown by multiple arrows C), and finally leaving through the heat exchange circulating liquid outlet 181, while the other portion of the heat exchange circulating liquid flowing from the first main channel 182 to the second main channel 183 through the auxiliary channel 184 (as shown by multiple dashed arrows E), and finally leaving through the heat exchange circulating liquid outlet 181. The second fluid channel subsystem 159 may include a structure similar to the first fluid channel subsystem 158, which will not be further elaborated here.

The two heat exchange circulating liquid inlets of two parallel fluid channel subsystems work in parallel. The heat exchange circulating liquid will cool or heat both battery arrays separately, the heat exchange circulating liquid will circulate throughout the battery arrays, and the cooling circulating path is shorter and more efficient than traditional single inlet designs. At least through the second housing integrated with the cooling plate as described in the present disclosure, it will advantageously provide sufficient and uniform cooling and heating performance for the battery arrays inside the battery pack 100. It should be understood that although the example in FIG. 6 shows that the heat exchange circulating liquid inlet 180 is located near the center of the second plate 152 and the heat exchange circulating liquid outlet 181 is located outside the second plate 152, the positions of the two can also be interchanged, and such embodiments are also included in the scope of the present disclosure.

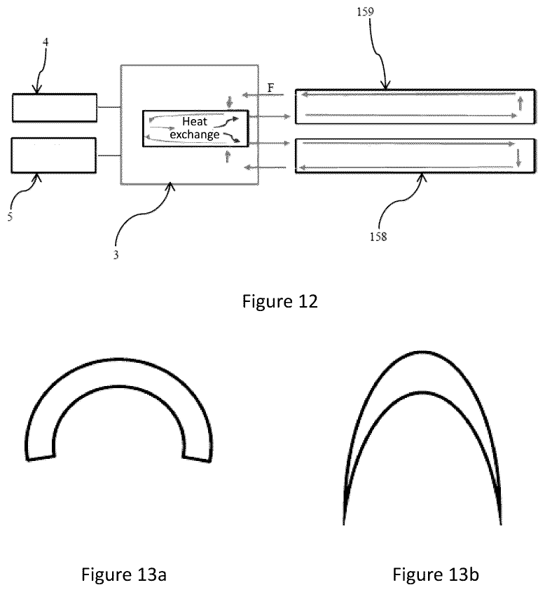

In an embodiment of the present disclosure, the fluid channel subsystem can be connected to a heat exchange system of the vehicle. In the embodiment shown in FIG. 12, the first fluid channel subsystem 158 and the second fluid channel subsystem 159 are respectively connected to the heat exchange system 3 of the vehicle 1, thereby exchanging heat with heat exchange circulating liquid inside the heat exchange system 3 (as shown by multiple arrows F in FIG. 12).

In addition, since the heat exchange circulating liquid inlets of both fluid channel subsystems are connected to the heat exchange system 3 of the vehicle 1, the temperature of the heat exchange circulating liquid input into the cooling plate 150 will be uniform and have the same temperature, thereby uniformly cooling or heating the battery arrays inside the battery pack 100.

The heat exchange system 3 can also be connected to a cooler 4 and a PTC (Positive Temperature Coefficient) heater 5 in the vehicle 1 to achieve heat exchange. When the battery pack 100 needs to be cooled down, the hot heat exchange circulating liquid is output from the cooling plate 150 to the heat exchange system 3 of the vehicle 1 and the hot heat exchange circulating liquid will be evenly cooled through the cooler 4, and then circulated back to the cooling plate 150 through the heat exchange system 3, thereby providing uniform and consistent cooling of the battery arrays inside the battery pack 100. When the battery pack 100 needs to be heated up, the cold heat exchange circulating liquid is output from cooling plate 150 to the heat exchange system 3 of the vehicle 1 and the cold heat exchange circulating liquid will be evenly heated through the PTC heater 5, and then circulated back to the cooling plate 150 through the heat exchange system 3, thereby providing uniform and consistent heating of the battery arrays inside the battery pack 100. Therefore, it is possible to maintain the operating temperature of the battery pack within a suitable range, enhance the efficiency of the battery, and thus, for example, increase the driving range of the vehicle.

It should be understood that although two sets of parallel independent fluid channel subsystems are used as examples in the above embodiments, other numbers of parallel independent fluid channel subsystems can be provided as needed, and such embodiments are also included in the scope of the present disclosure.

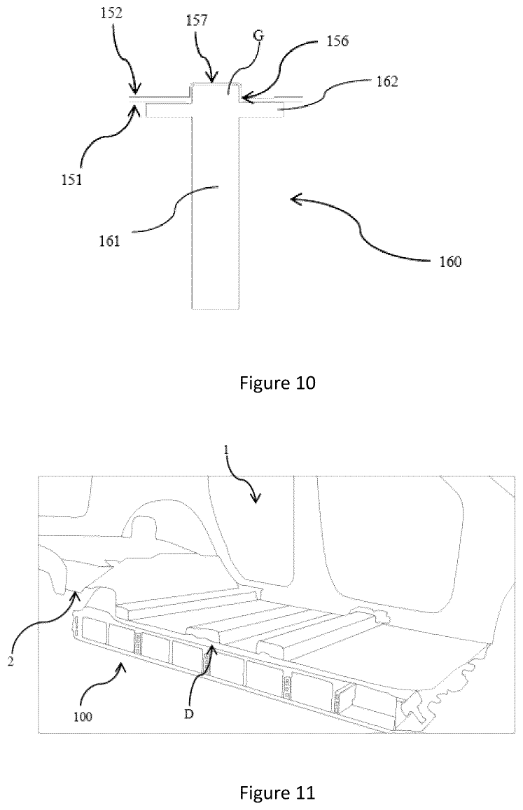

In an embodiment of the present disclosure, the first plate 151 may include a positioning pin hole 156, and the second plate 152 may include a positioning recess 157 corresponding to the positioning pin hole 156, as shown in FIGS. 5 and 6. In the embodiments shown in FIGS. 5 and 6, two positioning pin holes 156 are respectively arranged at both ends near the middle of the first plate 151, and correspondingly, two positioning recesses 157 are respectively arranged at both ends near the middle of the second plate 152. In other embodiments, other numbers of positioning pin holes and positioning recesses can also be included, and they can also be provided at other positions on the first and second plates, respectively. The positioning recess 157 can be configured to receive a removable positioning member 160, as shown in FIG. 10. The positioning pin hole 156 and the positioning recess 157 can assist in setting up the positioning fixture for welding, so that the welding joint can be accurately welded to the second housing through, for example, laser welding, as described in other parts of the present disclosure.

In an embodiment of the present disclosure, the removable positioning member 160 may include a positioning portion 161 and a limiting portion 162 that is transverse to the positioning portion 161. wherein the positioning portion 161 is configured to extend through the positioning pin hole 156 and be received by the positioning recess 157. The positioning portion 161 can include an end G, and the end G can have a height that is generally less than or equal to the height of the positioning recess 157, so that the positioning portion 161 does not disrupt the positioning recess 157. In addition, the limiting portion 162 is configured to limit movement range of the positioning portion 161, thereby further maintaining the integrity of the positioning recess 157. In the embodiment shown in FIG. 10, the removable positioning member 160 can be designed with a cross shape, the positioning portion 161 can provide a positioning function, and the limiting portion 162 can provide support and limit the positioning portion 161 to further maintain the integrity of the positioning recess 157 (for example, preventing the positioning portion 161 from passing through the positioning recess 157), and thus maintain the integrity of cooling plate 150 (for example, enabling the heat exchange circulating liquid inside the cooling plate 150 to flow in a sealed environment) and maintain stable performance of the cooling plate 150. Therefore, the cooling plate 150 described in the present disclosure can not only provide positioning for the housing of the battery pack 100, but also provide sealing function for the housing of the battery pack 100.

In an embodiment of the present disclosure, the second housing 130 can be manufactured by the following steps. First, the first plate 151 and the second plate 152 are welded together to form the cooling plate 150. Next, the first beam 52 and the second beam 53 are welded to the cooling plate 150. During this process, the cooling plate 150 can be placed with the first plate 151 facing downwards and the second plate 152 facing upwards, for example, in the orientation shown in FIG. 10, so the notch 155 on the second plate 152 is visible to an operator. The cooling plate 150 is positioned utilizing one or more removable positioning members 160 by extending the end G of the positioning portion 161 of the removable positioning member 160 through the positioning pin hole 156 of the first plate 151 and accommodating the end G at least partially within the positioning recess 157 under the action of the limiting portion 162.

The cooling plate 150 is fixed in place using a positioning fixture (not shown in the figure). Afterwards, at the position corresponding to notch 155 on the first plate 151, the second beam 53 is penetrated and welded to the first plate 151. After welding, the welding area of the second beam can be seen from the notch 155 (not shown in the figure). Next, the multiple first beams 52 are welded to the first plate 151, and the welding area 54 of the first beam is formed between the first beam 52 and the first plate 151.

The cooling plate 150 welded with the first beam 52 and the second beam 53 is then welded to the protective plate 131 through the edge overlap portion 132 of the protective plate 131 as described above.

The thermal insulation member 140 can then be bonded to the bottom of the protective plate 131 (not shown in the figure) to make the second housing 130. The second housing 130 and the first housing 110 of the present disclosure cooperate with each other, providing a suitable working temperature for the battery pack 100 under the synergistic effect of the thermal management components contained in the two, and the working temperature can be maintained stably for a long time without relying on the environmental temperature of the battery pack 100, thereby improving the performance of the battery pack 100 and providing corresponding vehicle driving range.

According to a second aspect of the present disclosure, a vehicle 1 is provided. As shown in FIG. 11, the vehicle 1 may include a battery pack 100 connected to a vehicle body 2. A gap D is formed between the battery pack 100 and the vehicle body 2, wherein the vehicle 1 comprises a guiding member that is generally adjacent to the battery pack 100 to guide airflow at least partially to bypass the gap D. For example, the guiding member may be the first guiding member 120 in the embodiment described above. In an embodiment of the present disclosure, the guiding member is generally arranged around ends and both sides of the battery pack 100, wherein the guiding member is connected to a housing of the battery pack 100, as described in other embodiments of the present disclosure. In another embodiment of the present disclosure, the guiding member can also be connected to the vehicle body 2, for example, it can be pasted onto the vehicle body 2.

It should be understood that, without mutual conflict, all embodiments, features, and advantages of the battery pack 100 described in the present disclosure are equally applicable to the vehicle according to the present disclosure. That is to say, all embodiments and their variants of the battery pack 100 mentioned above can be directly applied to the vehicle according to the present disclosure and directly combined with it. For the sake of brevity of the present disclosure, it will not be repeated here.

In summary, the present disclosure proposes a battery pack including a thermal management assembly and a vehicle including the battery pack. The solution provided in the present disclosure can provide a good working environment for the battery pack, thereby providing a more suitable working temperature for the battery pack, such as in hot summers or cold winters, and thus improving the working performance of the battery pack to a certain extent, such as increasing the driving range of the vehicle.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack including a thermal management assembly, comprising:
a first housing configured to connect to a vehicle body with a gap between at least a portion of the first housing and the vehicle body; and
a first guiding member arranged on the first housing, wherein the first guiding member on the first housing defines an area jointly with the first housing, and the first guiding member is configured to at least partially fill the gap and guide airflow to at least partially bypass the area.

2. The battery pack according to claim 1, wherein the first guiding member comprises a structure that continuously extends from a first end of the first housing to a first side of the first housing and to a second side of the first housing that is opposite the first side.

3. The battery pack according to claim 1, wherein the first guiding member comprises a first portion extending along a first end of the first housing, and a second portion and a third portion extending from both ends of the first portion towards a second end opposite to the first end, respectively, and wherein an angled or smooth transition is formed between the first portion and the second portion and between the first portion and the third portion.

4. The battery pack according to claim 1, wherein the first guiding member forms a substantially enclosed structure along an outer surface of the first housing.

5. The battery pack according to claim 2, further comprising at least one second guiding member connected to the first housing, wherein the at least one second guiding member is located in the area.

6. The battery pack according to claim 1, wherein the first guiding member is configured with a multi-layer structure and includes a support layer connected to an outer surface of the first housing and a foam sealing layer connected to the support layer.

7. The battery pack according to claim 6, wherein the outer surface forms a drainage channel with the support layer of the first guiding member.

8. The battery pack according to claim 1, further comprising a second housing integrated with a cooling plate, and the second housing is connected to the first housing to limit a battery storage space.

9. The battery pack according to claim 8, wherein the cooling plate comprises a first plate and a second plate connected to the first plate, and wherein at least one of the first plate and the second plate defines a fluid channel.

10. The battery pack according to claim 9, further comprising a thermal insulation member connected to the second housing.

11. The battery pack according to claim 10, wherein the thermal insulation member comprises an aluminum foil layer and a thermal insulation material inside the aluminum foil layer, and the thermal insulation material comprises aerogel or ceramic wool.

12. The battery pack according to claim 10, wherein the second housing includes a protective plate between the second plate and the thermal insulation member, and the protective plate includes an edge overlap portion at its edge.

13. The battery pack according to claim 11, wherein the second plate comprises at least one notch formed on it.

14. The battery pack according to claim 13, wherein the battery pack comprises a support beam welded to the first plate at a position corresponding to the at least one notch.

15. The battery pack according to claim 9, wherein the first plate includes a positioning pin hole, and the second plate includes a positioning recess corresponding to the positioning pin hole and configured to receive a removable positioning member.

16. The battery pack according to claim 15, wherein the removable positioning member includes a positioning portion configured to extend through the positioning pin hole and be received by the positioning recess and a limiting portion that is transverse to the positioning portion and configured to limit movement range of the positioning portion to maintain the positioning recess.

17. The battery pack according to claim 8, wherein the cooling plate comprises at least two sets of parallel independent fluid channel subsystems, wherein the at least two sets of independent fluid channel subsystems are connected to a heat exchange system of a vehicle.

18. The battery pack according to claim 17, wherein each set of the at least one sets of parallel independent fluid channel subsystems includes a heat exchange circulating liquid inlet and a heat exchange circulating liquid outlet, a first main channel and a second main channel extending between the heat exchange circulating liquid inlet and the heat exchange circulating liquid outlet, and multiple sets of auxiliary channels extending between the first main channel and the second main channel.

19. A vehicle having the battery pack according to claim 1, and further comprising a battery pack connected to a vehicle body and forming a gap with the vehicle body, wherein the vehicle includes a guiding member that is generally adjacent to the battery pack to guide airflow to at least partially bypass the gap.

20. The vehicle according to claim 19, wherein the guiding member generally surrounds ends and both sides of the battery pack, wherein the guiding member is connected to a housing of the battery pack or to the vehicle body.
